(19) United States
(12) Patent Application Publication
(10) Pub. No.: US 2008/0025408 A1
(43) Pub. Date: Jan. 31, 2008

(54) Video encoding

(76) Inventors: Sam Liu, Palo Alto, CA (US); Debargha Mukherjee, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/496,806

(22) Filed: Jul. 31, 2006

(51) Int. Cl. H04N 11/02; H04N 7/12

(52) U.S. Cl. 375/240.25; 375/240.26

(57) ABSTRACT

One embodiment in accordance with the invention is a method that can include determining a constraint that is associated with a decoder. Furthermore, the method can include determining a maximum number of reference B-frames that can be utilized to encode video content. Note that the maximum number is based on the constraint that is associated with the decoder.

### BACKGROUND

Currently there are different video compression standards that can be utilized for compressing and decompressing video content. For example, the Moving Pictures Experts Group (MPEG) has defined different video compression standards. One of their video compression standards that is becoming popular is MPEG-4 AVC (Advanced Video Coding), which is also referred to as MPEG-4 Part 10. Note that MPEG-4 AVC is similar to the H.264 video compression standard which is defined the International Telecommunication Union (ITU).

One of the reasons that MPEG-4 AVC is becoming popular is because of its ability to handle large amounts of video content data better than current standards, such as MPEG-2. That ability is desirable since High Definition (HD) video content is becoming more and more popular and it involves multiple times more video content data than traditional video systems. Given that fact, there is a desire by those HD video content broadcasters to fit as many HD channels within the same bandwidth they have been using traditionally.

However, one of the problems with MPEG-4 AVC is that its bitstream syntax allows for an almost unlimited number of frames for motion prediction in order to compress video content. It is noted that as the number of frames for motion prediction increase, there is also an increase in the number of frame buffers needed by a decoder to decompress the video content. Frame buffers can be costly, thereby preventing a cost effective decoding solution if limitations are not imposed on the compression process of video bitstreams. However, as more limitations are imposed, the quality of the resulting video bitstream can suffer. As such, it is desirable to use MPEG-4 AVC to generate the highest quality video bitstream based on a cost effective decoding solution.

### BRIEF DESCRIPTION OF THE DRAWINGS

FIG. 1 illustrates an exemplary motion referencing structure of a MPEG-1 and MPEG-2 presentation video stream.

FIG. 2 illustrates an exemplary motion referencing structure of a MPEG-4 AVC presentation video frame order that can be utilized in accordance with various embodiments of the invention.

FIG. 3 is an exemplary bitstream frame ordering based on the different video frame types of the presentation bitstream shown in FIG. 1.

FIG. 4 illustrates an exemplary one frame delay caused by buffering decoded video frames that conform to MPEG-1 and MPEG-2.

FIG. 5 illustrates an exemplary two frame delay caused by buffering decoded video frames associated with MPEG-4 AVC.

FIG. 6 is a flow diagram of an exemplary method in accordance with various embodiments of the invention.

FIG. 7 is a flow diagram of another exemplary method in accordance with various embodiments of the invention.

FIG. 8 is a block diagram of an exemplary system in accordance with various embodiments of the invention.

### DETAILED DESCRIPTION

Reference will now be made in detail to various embodiments in accordance with the invention, examples of which are illustrated in the accompanying drawings. While the invention will be described in conjunction with various embodiments, it will be understood that these various embodiments are not intended to limit the invention. On the contrary, the invention is intended to cover alternatives, modifications and equivalents, which may be included within the scope of the invention as construed according to the Claims. Furthermore, in the following detailed description of various embodiments in accordance with the invention, numerous specific details are set forth in order to provide a thorough understanding of the invention. However, it will be evident to one of ordinary skill in the art that the invention may be practiced without these specific details. In other instances, well known methods, procedures, components, and circuits have not been described in detail as not to unnecessarily obscure aspects of the invention.

Various embodiments in accordance with the invention can involve video compression. One of the techniques that can be used for video compression is referred to as motion prediction or motion estimation, which is well known by those of ordinary skill in the art. It is understood that video sequences contain significant temporal redundancies where the difference between consecutive frames is usually caused by scene object or camera motion (or both), which can be exploited for video compression. Motion estimation is a technique used to remove temporal redundancies that are included within video sequences.

It is noted that there are different standards for video compression. For example, the Moving Pictures Experts Group (MPEG) has defined different video compression standards. According to MPEG video compression standards, a video frame can be partitioned into rectangular non-overlapping blocks and each block can be matched with another block in a motion reference frame, also known as block matching prediction. It is understood that the better the match, the higher the achievable compression. The MPEG-1 and MPEG-2 video compression standards are each based on motion estimation because there is a lot of redundancy among the consecutive frames of videos and exploiting that dependency results in better compression. Therefore, it is desirable to have the smallest number of bits possible to represent a video bitstream while maintaining its content at an optimized visual quality.

As part of performing motion estimation, MPEG-1 and MPEG-2 include three different video frame types: I-frame, P-frame, and B-frame. Specifically, an I-frame does not utilize inter-frame motion (no motion prediction), which are independently decodable similar to still image compression, e.g., JPEG (Joint Photographic Experts Group). Additionally, a P-frame can be defined as a video frame that uses only one motion reference frame, either the previous P-frame or I-frame, which ever comes first temporally. Note that both the I-frame and the P-frame can be motion reference frames since other video frames can use them for motion prediction. Lastly, a B-frame can use two motion reference video frames for prediction, one previous video frame (can be either an I-frame or a P-frame) and one future video frame (can be either an I-frame or a P-frame). However, B-frames are not motion reference frames; they cannot be used by any other video frame for motion prediction. It is note that both P and B-frames are not independently decodable since they are dependent on other video frames for reconstruction. It is noted that the B-frames provide better compression than the P-frames, which provide better compression than the I-frames.

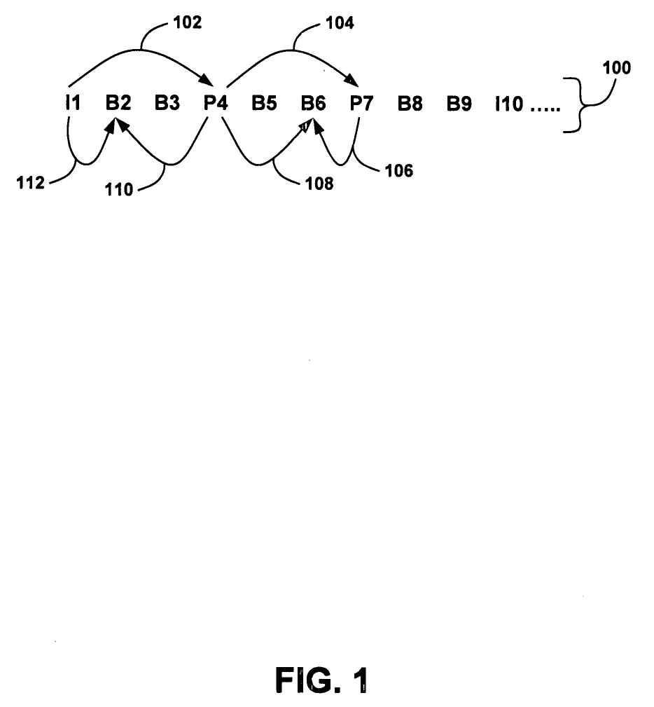

FIG. 1 illustrates an exemplary motion referencing structure of a MPEG-1 and MPEG-2 presentation video stream 100. It is pointed out that motion referencing is not shown for all video frames. Specifically, a motion estimation for a P-frame can involve using the previous I-frame or P-frame (which ever comes first temporally), which involves using one frame buffer for motion prediction or estimation. For example, for P-frames such as P4-frame of presentation video stream 100, a motion estimation can involve using the previous I1-frame, as indicated by arrow 102. Furthermore, a P7-frame of presentation video stream 100 can involve using the previous P4-frame for motion estimation, as indicated by arrow 104.

It is understood that a motion estimation for a B-frame involves using the previous I-frame or P-frame (which ever comes first temporally) and the future I-frame or P-frame (which ever comes first temporally), which involves using two frame buffers for bidirectional motion estimation or prediction. For example, for B-frames such as B2-frame of presentation video stream 100, a motion estimation can involve using the previous I1-frame (indicated by arrow 112) along with the future P4-frame (indicated by arrow 110) for motion prediction or estimation. Additionally, a B6-frame of presentation video stream 100 can involve using the previous P4-frame (indicated by arrow 108) along with the future P7-frame (indicated by arrow 106) for motion prediction or estimation.

Within FIG. 1, the presentation video stream 100 includes exemplary video frames, but is not limited to, I1-frame, which is followed by B2-frame, which is followed by B3-frame, which is followed by P4-frame, which is followed by B5-frame, which is followed by B6-frame, which is followed by P7-frame, which is followed by B8-frame, which is followed by B9-frame, which is followed by I10-frame, which can be followed by other video frames.

As mentioned earlier, each of the MPEG-1 and MPEG-2 video compression schemes restricts motion prediction (or estimation) to a maximum of two reference video frames. However, MPEG-4 AVC (Advanced Video Coding), in contrast, generalizes motion estimation by allowing a much larger number of reference video frames. Note that MPEG-4 AVC (also known as MPEG-4 Part 10) is similar to the International Telecommunication Union (ITU) H.264 standard. It is understood that MPEG-4 AVC codec provides the liberty to define an arbitrary number of motion reference frames. For example, just about any video frame that has been previously encoded can be a reference video frame since it is available for motion estimation or prediction. It is pointed out that previously encoded video frames can be from temporal past video frames or future video frames (relative to the current video frame to be encoded). In contrast, within MPEG-1 and MPEG-2, the I-frames and P-frames can be used as motion reference video frames, but not the B-frames. However, within MPEG-4 AVC, the B-frames can also be motion reference video frames, called reference B-frames (denoted by “Br”). Within MPEG-4 AVC, the definitions for generalized P and B video frames are as follows. The P-frame can use multiple motion reference video frames as long as they are from the temporal past. Additionally, the B-frames can use multiple motion reference frames from the temporal past or future as long as they are previously encoded.

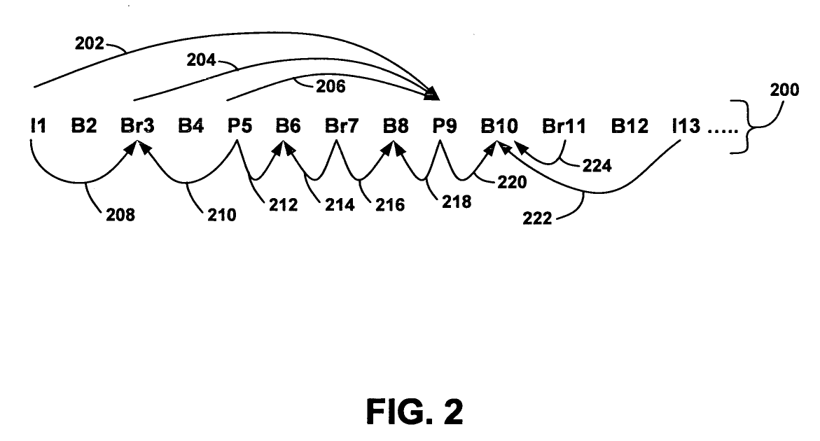

FIG. 2 illustrates an exemplary motion referencing (or estimating) structure of a MPEG-4 AVC presentation video frame order 200 that can be utilized in accordance with various embodiments of the invention. It is pointed out that motion referencing (or estimating) is not shown for all video frames. Note that within presentation frame order 200, “Br” denotes a reference B-frame. As shown by MPEG-4 AVC presentation video frame order 200, there are many possibilities in which motion estimation can be performed. For example, motion estimation for P-frames such as P9-frame, can involve using any previous reference frame from the temporal past, such as I1-frame (as indicated by arrow 202), Br3-frame (as indicated by arrow 204), and/or P5-frame (as indicated by arrow 206).

As for B-frames, there are two different types associated with MPEG-4 AVC: reference Br-frames and B-frames. Specifically, motion estimation for a Br-frame, e.g. Br3-frame, can involve using other reference video frames from both the temporal past and future as long as they are already encoded. For example, a motion estimation for Br3-frame of presentation frame order 200 can involve using the previous temporal I1-frame (as indicated by arrow 102) and the future temporal P5-frame (as indicated by arrow 210).

Lastly within FIG. 2, a motion estimation for B-frames (e.g., B10-frame) can also use reference frames, including Br-frames, from both the temporal past and future, but they themselves cannot be used as reference frames. For example, a motion estimation for B10-frame of presentation frame order 200 can involve using the previous temporal P9-frame (as indicated by arrow 220), the future temporal Br11-frame (as indicated by arrow 224), and the future temporal I13-frame (as indicated by arrow 222). Furthermore, a motion estimation for B8-frame can involve using the previous temporal Br7-frame (as indicated by arrow 216) and the future temporal P9-frame (as indicated by arrow 218). Moreover, a motion estimation for B6-frame can involve using the previous temporal P5-frame (as indicated by arrow 212) and the future temporal Br7-frame (as indicated by arrow 214).

It is noted that during motion estimation, it is desirable to utilize reference frames that are as close to the current frame as possible. As such, it is desirable to utilize Br-frames (e.g., Br11 and Br7) as shown in presentation video frame order 200. For example, if you have a reference frame that is too far away from the current frame, the reference frame might not be able to provide a good motion match because the object may be out of view, or changed orientation.

Within FIG. 2, the presentation frame order 200 includes exemplary video frames, but is not limited to, I1-frame, which is followed by B2-frame, which is followed by Br3-frame, which is followed by B4-frame, which is followed by P5-frame, which is followed by B6-frame, which is followed by Br7-frame, which is followed by B8-frame, which is followed by P9-frame, which is followed by B10-frame, which is followed by Br11-frame, which is followed by B12-frame, which is followed by I13-frame, which can be followed by other video frames.

It is noted that FIG. 1 illustrates the display or presentation order 100 of the video frames, which is the temporal sequence of how the video frames should be presented to a display device. It is appreciated that the B-frames of presentation bitstream order 100 are dependent on both past and future video frames because of bi-directional motion prediction (or estimation). However, using future frames involves shuffling of the video frame order of presentation bitstream order 100 so that the appropriate reference frames are available for encoding or decoding of the current frame. For example, both the B5-frame and the B6-frame rely on the P4-frame and the P7-frame, which have to be encoded prior to the encoding of the B5 and B6-frames. Consequently, the video frame ordering in MPEG bitstreams is not temporal linear and differs from the actual presentation order.

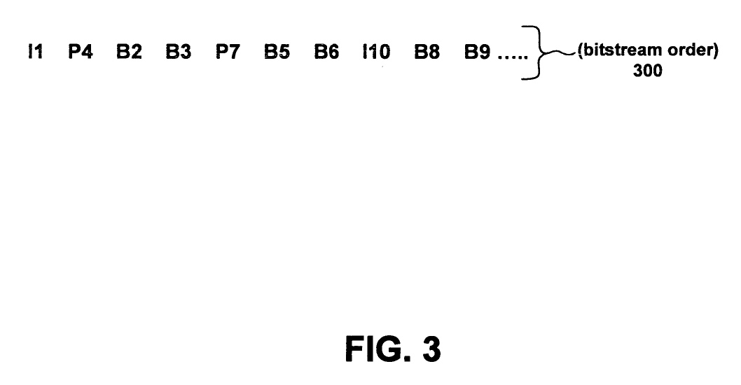

For example, FIG. 3 is an exemplary bitstream frame ordering 300 based on the different video frame types of presentation bitstream 100, shown in FIG. 1. Specifically, the first video frame of the video bitstream 300 is the I1-frame since its encoding does not rely on any reference video frames and it is the first video frame of presentation bitstream 100. The P4-frame is next since its encoding is based on the I1-frame and it has to be encoded prior to the encoding of the B2-frame. The B2-frame is next since its encoding is based on both the I1-frame and the P4-frame. The B3-frame is next since its encoding is also based on both the I1-frame and the P4-frame. The P7-frame is next since its encoding is based on the P4-frame and it has to be encoded prior to the encoding of the B5-frame. The B5-frame is next since its encoding is based on both the P4-frame and the P7-frame. The B6-frame is next since its encoding is also based on both the P4-frame and the P7-frame. The I10-frame is next since it has to be encoded prior to the encoding of the B8 and B9-frames. The B8-frame is next since its encoding is based on both the P7-frame and the I10-frame. The B9-frame is next since its encoding is also based on both the P7-frame and the I10-frame. In this manner, the bitstream frame ordering 300 can be generated based on the ordering of presentation bitstream 100 (shown in FIG. 1). As such, by utilizing bitstream frame ordering 300, the appropriate reference frames are available for encoding or decoding of the current video frame.

Within FIG. 3, the video bitstream 300 includes exemplary video frames, but is not limited to, I1-frame, which is followed by P4-frame, which is followed by B2-frame, which is followed by B3-frame, which is followed by P7-frame, which is followed by B5-frame, which is followed by B6-frame, which is followed by I10-frame, which is followed by B8-frame, which is followed by B9-frame, which can be followed by other video frames.

It is noted that because of the shuffled frame ordering of video bitstream 300, a video frame cannot immediately be displayed or presented upon decoding. For example, after decoding video frame P4 of video bitstream 300, it can be stored since it should not be displayed or presented until video frames B2 and B3 have been decoded and displayed. However, this type of frame buffering can introduce delay.

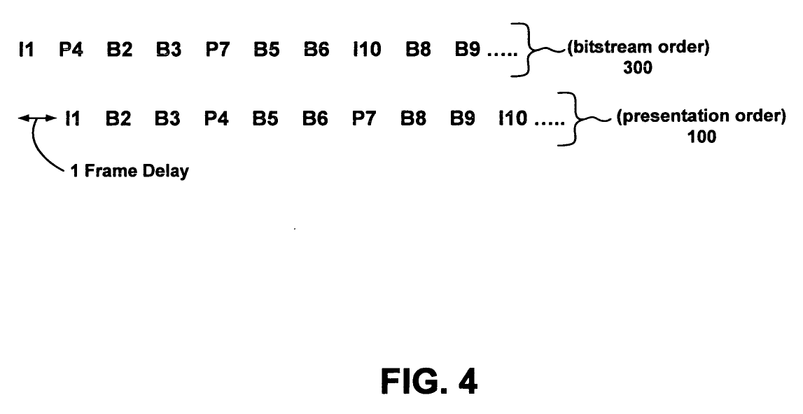

For example, FIG. 4 illustrates an exemplary one frame delay caused by buffering decoded video frames that conform to MPEG-1 and MPEG-2. Specifically, FIG. 4 includes the video bitstream frame order 300 (of FIG. 3) along with its corresponding video presentation order 100 (of FIG. 1), which is located below the bitstream order 300. Furthermore, the presentation ordering 100 is shifted to the right by one frame position, thereby representing a one frame delay caused by the buffering process of decoded video frames of bitstream 300 before they are displayed or presented.

For instance, once the I1-frame of bitstream 300 is decoded, it should not be displayed or presented since the next video frame, the B2-frame, cannot be decoded and displayed until after the P4-frame has been decoded. As such, the I1-frame can be buffered or stored. Next, once the P4-frame has been decoded utilizing the I1-frame, the I1-frame can be displayed or presented while the P4-frame can be buffered or stored. After which, the B2-frame can be decoded using both the I1-frame and the P4-frame so that it can be display or presented. It is understood that decoding of the bitstream 300 results in a 1 frame delay, which can be referred to as the decoding presentation delay. For MPEG-1 and MPEG-2, it is appreciated that the maximum delay is one frame independent of the motion referencing structure.

It is noted that given the one frame delay of FIG. 4, a decoder would have a frame buffer for the delay along with two additional frame buffers for storing two reference frames during decoding.

Decoding presentation delay, however, is a more serious issue for new video compression/decompression standards, such as, MPEG-4 AVC because the presentation delay can be unbounded due to the flexible motion referencing structure of MPEG-4 AVC.

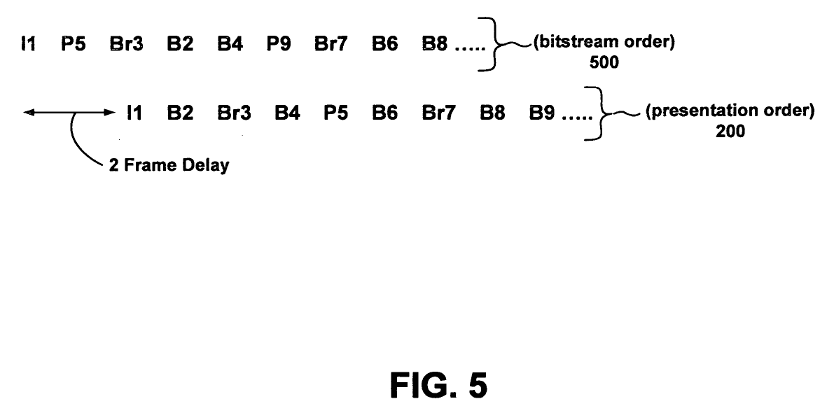

For example, FIG. 5 illustrates an exemplary two frame delay caused by buffering decoded video frames associated with MPEG-4 AVC. Specifically, FIG. 5 includes a video bitstream frame order 500 that corresponds to the video presentation frame order 200 (of FIG. 2), which is located below the bitstream order 500. Additionally, the presentation frame ordering 200 is shifted to the right by two frame positions, thereby representing a 2 frame delay caused by the buffering process of decoded video frames of bitstream frame order 500 before they are displayed or presented. Specifically, it can be seen in FIG. 5 that by using one reference Br-frame (e.g., Br3) between consecutive pairs of I and P-frames (I/P frames) or consecutive pairs of P-frames (P/P frames), the presentation delay is increased by one over the presentation delay of FIG. 4. Note that the value of the presentation delay of FIG. 5 can grow without bound as more and more reference Br-frames are located between consecutive I/P frames or P/P frames.

In practice, it can be desirable that some actual decoders restrict the presentation delay. For example, as the presentation delay increases, the number of decoder frame buffers increases thereby resulting in a more and more expensive decoder. Moreover, as the presentation delay increases, the decoder may be unable to properly operate, such as, during teleconferencing where presentation delay is usually unacceptable. However, it is noted that as actual decoders are implemented to restrict presentation delay, the video quality of MPEG-4 AVC bitstreams will also be negatively impacted.

Within FIG. 5, it is appreciated that the video bitstream order 500 can be generated in a manner similar to the video bitstream order 300. However, the video bitstream order 500 of FIG. 5 can be based on the motion estimation encoding that was described above with reference to the video presentation frame order 200 of FIG. 2.

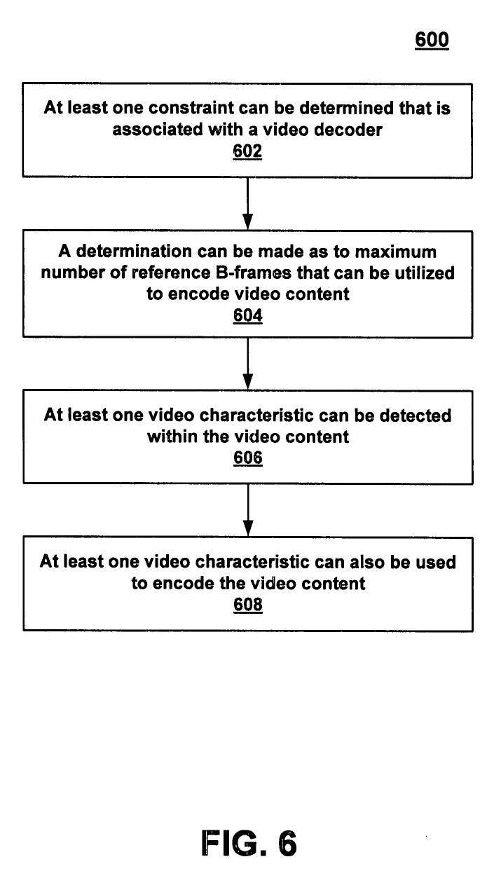

FIG. 6 is a flow diagram of an exemplary method 600 in accordance with various embodiments of the invention for optimizing the quality of video bitstreams based on at least one decoder constraint. Method 600 includes exemplary processes of various embodiments of the invention that can be carried out by a processor(s) and electrical components under the control of computing device readable and executable instructions (or code), e.g., software. The computing device readable and executable instructions (or code) may reside, for example, in data storage features such as volatile memory, non-volatile memory and/or mass data storage that can be usable by a computing device. However, the computing device readable and executable instructions (or code) may reside in any type of computing device readable medium. Although specific operations are disclosed in method 600, such operations are exemplary. Method 600 may not include all of the operations illustrated by FIG. 6. Also, method 600 may include various other operations and/or variations of the operations shown by FIG. 6. Likewise, the sequence of the operations of method 600 can be modified. It is noted that the operations of method 600 can be performed manually, by software, by firmware, by electronic hardware, or by any combination thereof.

Specifically, method 600 can include determining at least one constraint that is associated with a video decoder. A determination can be made of a maximum number of reference B-frames that can be utilized to encode video content. Note that the maximum number can be based on at least one constraint that is associated with the video decoder. At least one video characteristic can be detected within the video content. At least one video characteristic can also be used to encode the video content.

At operation 602 of FIG. 6, at least one constraint can be determined that is associated with a video decoder. Note that operation 602 can be implemented in a wide variety of ways. For example in various embodiments, the video decoder can include, but is not limited to, a plurality of frame buffers. In various embodiments, the constraint can be one or more of the following, but is not limited to such, equal to the number of the plurality of frame buffers included by the video decoder, equal to an allowable presentation frame delay associated with the video decoder. In various embodiments, it is noted that the video decoder can tell a video encoder how many frame buffers it has for decoding. It is pointed out that is some situation, the presentation frame delay is not really an issue. For example in various embodiments, the presentation delay of the playback of a DVD is usually not an issue. However, for interactive activity such as communication, the video telephony type, and video conference, delay can be a problem. It is noted that motion referencing buffers and/or presentation delay can be related to the amount of frame buffers utilized for decoding. They have little impact on MPEG-1 and MPEG-2 bitstreams because they take on small values, but for MPEG-4 AVC the values can be too large for practical implementation, making them considerable design variables. In digital video consumer market, such as DVD players, decoders are usually for the masses and their cost should be kept low for profitability. Memory in the form of frame buffers are relatively expensive, so limiting the motion referencing and/or presentation buffers is typically dictated at the decoding end (e.g., DVD players). Such decoder hardware constraints can have implications on the video quality of the MPEG-4 AVC bitstreams. As such, method 600 can take given preset parameter values, and then determine how the video bitstream can be optimized at the encoding end. Note that operation 602 can be implemented in any manner similar to that described herein, but is not limited to such.

At operation 604, a determination can be made as to a maximum number of reference B-frames that can be utilized to encode video content. It is noted that the maximum number can be based on the constraint that is associated with the video decoder. It is understood that operation 604 can be implemented in a wide variety of ways. For example in various embodiments, the maximum number can be, but is not limited to, equal to the number of the plurality of frame buffers minus two, and/or equal to the allowable presentation frame delay associated with the video decoder minus one. Specifically, given N number of motion reference frame buffers, the maximum number of Br-frames is N−2. Given D as the presentation frame delay, the maximum number of Br-frames is D−1. Thus, the net number of allowable Br-frames is the smaller of these two values: min {N−2, D−1}. However, it is understood that either N−2 or D−1 can be utilized as the maximum for operation 604. It is understood that since MPEG-4 AVC allows reference B-frames (Br-frames), it is desirable to use as many of the Br-frames as possible between consecutive I/P pair of the encoding motion reference structure. As mentioned herein, the maximum number of Br-frames is determined both by the available decoding motion referencing buffers and decoding presentation delay. Note that operation 604 can be implemented in any manner similar to that described herein, but is not limited to such.

At operation 606 of FIG. 6, at least one video characteristic can be detected within the video content. It is appreciated that operation 606 can be implemented in a wide variety of ways. For example in various embodiments, operation 606 can be implemented in any manner similar to that described herein, but is not limited to such.

At operation 608, at least one video characteristic can also be used to encode the video content. It is understood that operation 608 can be implemented in a wide variety of ways. For example in various embodiments, operation 608 can be implemented in any manner similar to that described herein, but is not limited to such.

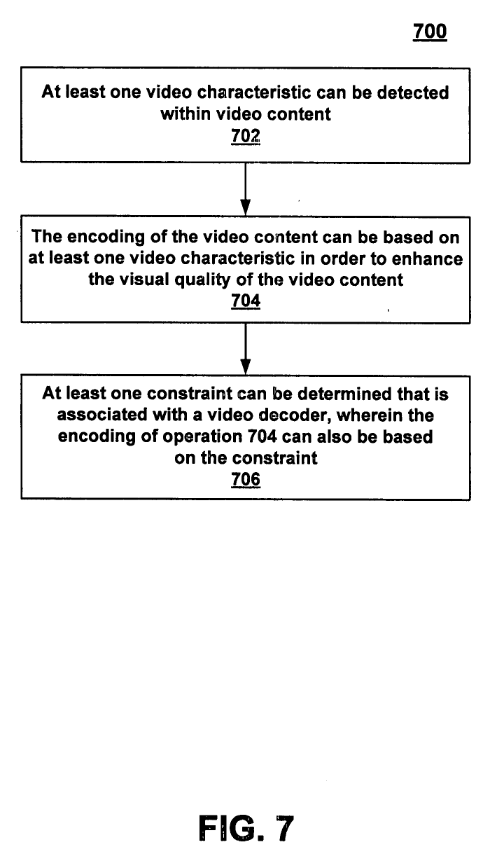

FIG. 7 is a flow diagram of an exemplary method 700 in accordance with various embodiments of the invention for adapting the encoding of video content based on at least one video characteristic of the video content. Method 700 includes exemplary processes of various embodiments of the invention that can be carried out by a processor(s) and electrical components under the control of computing device readable and executable instructions (or code), e.g., software. The computing device readable and executable instructions (or code) may reside, for example, in data storage features such as volatile memory, non-volatile memory and/or mass data storage that can be usable by a computing device. However, the computing device readable and executable instructions (or code) may reside in any type of computing device readable medium. Although specific operations are disclosed in method 700, such operations are exemplary. Method 700 may not include all of the operations illustrated by FIG. 7. Also, method 700 may include various other operations and/or variations of the operations shown by FIG. 7. Likewise, the sequence of the operations of method 700 can be modified. It is noted that the operations of method 700 can be performed manually, by software, by firmware, by electronic hardware, or by any combination thereof.

Specifically, method 700 can include detecting at least one video characteristic within video content. The encoding of the video content can be based on at least one video characteristic in order to enhance the visual quality of the video content. The method 700 can include determining a constraint that is associated with a video decoder, wherein the encoding can also be based on the constraint. It is understood that method 700, in various embodiments, can be used to determine the best Br-frame locations within a motion reference structure encoding.

For example, given one Br between two consecutive I/P (assume N=3, D=2, as mentioned above), therefore the possible Br locations are:
“P B Br B P”, “P Br B B P’, and “P B B Br P”.
   The bitstream should use the structure that gives the best video quality. The outcome of the decision is dependent on the video characteristics, such as the amount of motion between frames, scene changes, object occlusions, etc. As an example how adaptive Br can be utilized for video quality at scene changes, consider the following simpler structure, “I Br B P” or “I B Br P”. The “I Br B P” can be chosen if a content scene change is immediately after the I-frame (thereby rendering the I-frame basically useless for motion estimation), and choose “I B Br P” if the content scene change is right before the P frame (thereby rendering the P-frame basically useless for motion estimation).

At operation 702 of FIG. 7, at least one video characteristic can be detected within video content. Note that operation 702 can be implemented in a wide variety of ways. For example in various embodiments, the video characteristics at operation 702 can be, but is not limited to, at least one content scene change within the video content, at least one object that is occluded, an amount of motion between at least two frames of the video content, and the like. In various embodiments, it is noted that a scene change detector can be utilized to detect at least one video characteristic. In various embodiments, at least one video characteristic can be implemented by generate the bitstream based on different motion reference patterns (for example) and choose the one that results in the least number of bits. In various embodiments, at least one video characteristic can be implemented at the encoder end by encoding and then decoding the video content and then comparing different decoded video with the original video. Then a metric could be used to compare the decoded videos and then that one can be chosen. It is understood that operation 702 can be implemented in any manner similar to that described herein, but is not limited to such.

At operation 704, the encoding of the video content can be based on at least one video characteristic in order to enhance the visual quality of the video content. It is understood that operation 704 can be implemented in a wide variety of ways. For example in various embodiments, at least one video characteristic can be utilized to determine the motion reference frame structure that results in utilizing as many reference frames as possible for the motion estimation and for the encoding of the Br-frames and the B-frames. Note that operation 704 can be implemented in any manner similar to that described herein, but is not limited to such.

At operation 706 of FIG. 7, at least one constraint can be determined that is associated with a video decoder, wherein the encoding of operation 704 can also be based on the constraint. It is appreciated that operation 706 can be implemented in a wide variety of ways. For example in various embodiments, operation 706 can be implemented in any manner similar to that described herein, but is not limited to such.

It is noted that method 600 and 700 can be combined in a wide variety of ways. For example, the encoding of video content can be based the number of motion reference frame buffers, desired presentation frame delay, and/or modifying the encoding based on at least one video characteristic of the video content. Note that each of these can be used individually or in any combination thereof. It is understood that using all of them may provide a better result than using just one of them. For example, you could choose the maximum number of Br-frames to use, but the pattern of the motion reference structure can be fixed. Or instead of using the maximum number of Br-frames, the pattern of the motion reference structure can be adaptive.

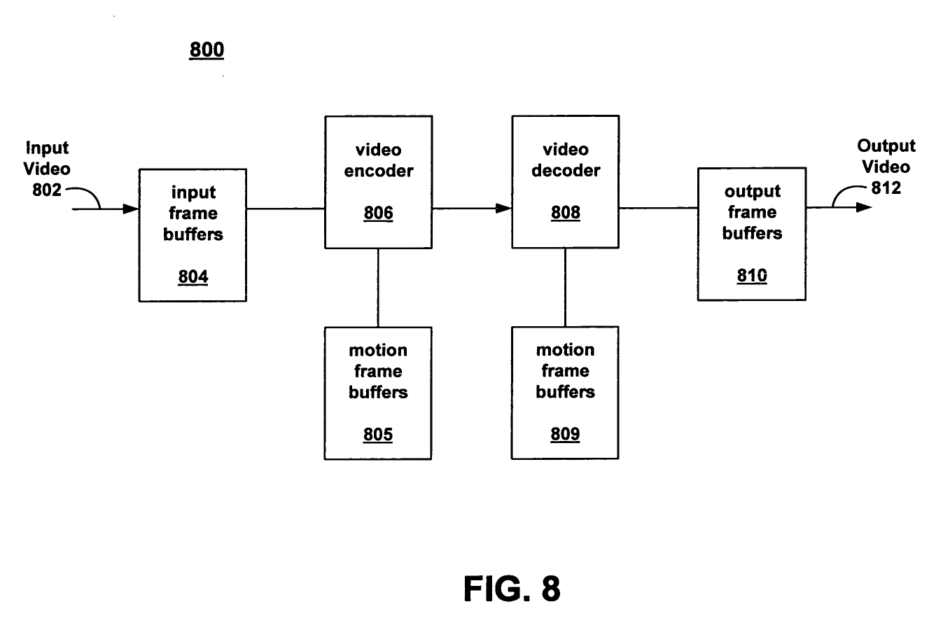

FIG. 8 is a block diagram illustrating an exemplary encoder/decoder system 800 in accordance with various embodiments of the invention. System 800 can include, but is not limited to, input frame buffers 804 and motion frame buffers 805 that can be coupled to input video 802 and the video encoder 806. Note that the frame buffers 804 and 805 can be implemented with one or more frame buffer memories. The video encoder 806 can be coupled to a video decoder 808. The video decoder 808 can be coupled to motion frame buffers 809 and output frame buffers 810, which can be coupled to output an output video 812. Note that the frame buffers 809 and 810 can be implemented with one or more frame buffer memories. It is understood that the video decoder 808 can be coupled to the frame buffers 809 and 810 and the video encoder 806. As such, the video decoder 808 can inform or transmit the number of frame buffers it can use for decoding to the video encoder 806.

It is understood that the system 800 can be implemented with additional or fewer elements than those shown in FIG. 8. Note that the video encoder 806 and the video decoder 808 can each be implemented with software, firmware, electronic hardware, or any combination thereof.

Within FIG. 8, it is appreciated that system 800 can be utilized to determine the motion reference structure that will produce the best or optimal video quality bitstreams in any manner similar to that described herein, but is not limited to such.

In various embodiments, system 800 can be implemented in a wide variety of ways. For example, system 800 can be implemented as a combination of a DVD player and a DVD encoder. Specifically in various embodiments, the video decoder 808 and the frame buffers 809 and 810 can be implemented as part of a DVD player. Furthermore, in various embodiments, the video encoder 806 and the frame buffers 804 and 805 can be implemented as part of a DVD encoding system. However, it is noted that the video encoder 806 may have to know the constraints of the video decoder 808 and the frame buffers 809 and 810 of the DVD player in order to determine the motion reference structure used to encode the input video 802.

The foregoing descriptions of various specific embodiments in accordance with the invention have been presented for purposes of illustration and description. They are not intended to be exhaustive or to limit the invention to the precise forms disclosed, and obviously many modifications and variations are possible in light of the above teaching. The invention can be construed according to the Claims and their equivalents.

What is claimed is:

1. A method comprising:
determining a constraint that is associated with a decoder; and
determining a maximum number of reference B-frames that can be utilized to encode video content, said maximum number is based on said constraint that is associated with said decoder.

2. The method of claim 1, wherein said decoder comprises a plurality of frame buffers.

3. The method of claim 2, wherein said constraint is equal to the number of said plurality of frame buffers.

4. The method of claim 2, wherein said maximum number is equal to said constraint minus two.

5. The method of claim 1, wherein said constraint is equal to an allowable presentation frame delay associated with said decoder.

6. The method of claim 5, wherein said maximum number is equal to said constraint minus one.

7. The method of claim 1, further comprising:
detecting a content scene change within said video content.

8. The method of claim 7, further comprising:
utilizing said content scene change to encode said video content.

9. Application instructions on a computer-usable medium where the instructions when executed effect a method comprising:
determining a constraint that is associated with a video decoder; and
determining a maximum number of reference B-frames that can be utilized to encode video content, said maximum number is based on said constraint that is associated with said video decoder.

10. The application instructions of claim 9, wherein:
said video decoder comprises a plurality of frame buffers; and
said constraint is equal to the number of said plurality of frame buffers.

11. The application instructions of claim 10, wherein said maximum number is equal to said constraint minus the value of two.

12. The application instructions of claim 9, wherein said constraint is. equal to an allowable presentation frame delay associated with said video decoder.

13. The application instructions of claim 12, wherein said maximum number is equal to said constraint minus the value of one.

14. The application instructions of claim 9, further comprising:
detecting a content scene change within said video content.

15. The application instructions of claim 14, further comprising:
utilizing said content scene change to encode said video content.

16. A method comprising:
detecting a video characteristic within video content; and
encoding said video content based on said video characteristic enhance the visual quality of said video content.

17. The method of claim 16, wherein said video characteristic is a content scene change within said video content.

18. The method of claim 16, wherein said video characteristic is an object that is occluded.

19. The method of claim 16, wherein said video characteristic is an amount of motion between at least two frames of said video content.

20. The method of claim 16, further comprising:
determining a constraint that is associated with a video decoder, wherein said encoding is also based on said constraint.
